(19) United States
(12) Patent Application Publication
(10) Pub. No.: US 2008/0093356 A1
(43) Pub. Date: Apr. 24, 2008

(54) Portable hypothermia treatment pad and kit

(76) Inventor: Gian Vittorio Pizzi, Saronno (IT)

Correspondence Address: WILLIAM NITKIN, 1320 CENTRE STREET, SUITE 300, NEWTON, MA, 02459, US

(21) Appl. No.: 11/973,704

(22) Filed: Oct. 10, 2007

(30) Foreign Application Priority Data
Oct. 18, 2006 (IT) VA-2006/U/000042

(51) Int. Cl. H05B 3/34

(52) U.S. Cl. 219/474

(57) ABSTRACT

A dual-purpose, portable, hypothermia treatment pad for use in warming a patient suffering from hypothermia and for heating body infusion fluid container(s) in preparation for such fluid to be infused in a body, such pad provided in a kit that further includes a carrying bag and multiple electrical connectors to different electrical power sources for providing electrical current to the pad, such carrying bag having heat-retaining sides when holding the pad around body infusion fluid container(s) placed within the pad and held on the carrying bag to warm such container(s).

### BACKGROUND OF THE INVENTION

1. Field of the Invention

The invention herein relates to a portable hypothermia treatment pad and kit for use in treating hypothermia and also for warming body infusion fluid containers in preparation for such fluid to be infused in a body.

2. History of the Prior Art

Body temperature is one of the key aspects of human life. Normal functioning body temperature is around 37° C. Hypothermia occurs when the body's core temperature drops below 37° C. Severe hypothermia occurs when the core temperature goes below 31° C. Serious medical problems arise due to hypothermia starting with uncontrolled, intense shivering and loss of coordination. As the body's core temperature drops further, the shivering slows or stops. Also the muscles begin to stiffen, and mental confusion and apathy set in. Speech can become slow, vague and slurred; and breathing can become slower and shallower. As the body's core temperature continues to drop, the shunting of blood to the body's core manifests itself as bluish lips and fingertips which result from poor oxygenation of the tissues near the body's surface. Further, decreased circulation results in a buildup of acid metabolites or waste products in the muscles of the extremities until shivering stops completely and is replaced with muscular rigidity. The pulse and respiration also begin to slow as the body's core further cools. Hypothermia can often occur when a person is exposed to cold temperatures outdoors without sufficient covering and in other situations, such as being immersed in cold water and the like.

It is not merely sufficient to re-heat a victim suffering from hypothermia; the heating itself must be controlled. First there must be a prevention of further heat loss, and then re-warming must be accomplished at a slow rate. One must re-warm the body's core before warming the outer extremities to avoid inducing lethal side effects during re-warming. The body, being in a state of vasoconstriction wherein blood flow to the extremities has halted in order to conserve heat in the critical core of the body, must be warmed extremely slowly. Warming a person suffering from hypothermia too quickly causes the induction of vasodialation and may precipitate re-warming shock and metabolic acidosis where the legs and arms at the periphery are warmed before the core of the body encompassing the heart and lungs. Furthermore, the rapid shunting of cold blood from the extremities to the body's core as a direct result of vasodialation may cause the body's core temperature to drop. Prevention of such vasodialation is the reason that it is imperative that a hypothermia victim's extremities not be re-warmed before the body's core is rewarmed. If vasodialation occurs, cold blood returning to the heart from the extremities may put the patient into ventricular fibrillation.

The treatment of hypothermia patients includes the application of heat to the skin in the area of the chest, and in the prior art many forms of such devices are disclosed. Generally such device include heat blankets, many of which have ducts in them to provide the circulation of a heating medium such as air or fluid within the ducts in the blanket to slowly warm the patient by placing such heating blankets in close proximity to the patient's body. Many of these heating blankets utilize various heating zones to heat various parts of the body in a desired sequence. Heat blankets can be especially useful after putting a patient into a hypothermic state as a function of surgery where body parts have been cooled to create a hypothermia-like effect.

### SUMMARY OF THE INVENTION

It is an object of the present invention to provide a hypothermia treatment pad which is portable in nature and which is a component of a kit which has two modes of use, as described further below. People involved in rescue situations such as by ambulance, helicopter, mountain rescue, civil protection and other rescue efforts as well as medical personnel attending patients who have been cooled in operating theaters and intensive care units have long been aware that the clinical warming of patients during a hypothermic emergency is extremely important. The initial treatment of hypothermia can include passive types of approaches, such as applying insulating blankets or metallic covers around the patient's body to reduce heat loss. However these steps are absolutely insufficient for the prevention of hypothermia and its serious consequences of infection, cardio-circulatory problems and thermal shock. In an emergency situation it is desirable to have a portable hypothermia treatment pad that can be used outdoors, in buildings, or in hospitals that is safe for the patient and convenient for the user; that can be easily cleaned and disinfected; and which works to slowly raise the core temperature of the patient's body to a point at which the body can maintain normothermia.

The present invention in a first mode of use includes a heat-regulated hypothermia pad of a size to cover most adult average-size thoraxes. The hypothermia pad has a PVC bio-compatible cover which can be positioned on the torso of the patient without the need for removing the patient's clothing. The hypothermia pad can be connected to a variety of power sources by a plurality of various connection means that are contained within a carrying bag. The carrying bag and its components are provided in the form of a portable kit so as to be conveniently usable in a variety of emergency situations. The pad is soft, lightweight, and flexible, being made of a strong PVC sheet material, and utilizes microcarbon fibers in its internal circuitry, as will be described further below. The kit includes a carrying bag which is lined with a heat-resistant, insulating material and has straps to retain a rechargeable battery pack, an automobile-type power connector, and a direct power connector to a local power source. The kit is compact and can be conveniently stored prior to when it is needed to be used, such as on an ambulance, boat, or in an emergency helicopter and the like. When the kit is needed to be used, the carrying bag is opened and the pad can be placed on the thorax of the patient; and the power, which is 12 volts, can be obtained from a selected power source, as described further below.

In a second mode of use the kit can be used to warm body infusion fluid containers, such as bags or vials of fluid, before the fluids contained therein are entered into the patient's body. The hypothermia pad of this invention can be wrapped around the body infusion fluid container(s), and the selected power source can be engaged. Up to 4-6 body infusion fluid containers, such as bottles, bags or vials, can be held within the pad, which can be once or twice folded over such containers, and then enclosed within the carrier bag which has insulated sides and a lining of a metallic foil material which delays heat from escaping. The pad has a controlled, low-warming temperature so as not to warm the body infusion fluid containers to too high a temperature once such containers are enclosed within the pad and carrying bag. The pad can sufficiently warm the body infusion fluid containers to the proper temperature to avoid thermal shock to the patient when such fluids are infused into the patient's body.

### BRIEF DESCRIPTION OF THE DRAWINGS

FIG. 1 illustrates a perspective view of a patient suffering from hypothermia on a stretcher showing the pad of this invention placed on the patient's thorax and the plurality of power sources that can be selected to provide power to heat the pad.

FIG. 2 illustrates a perspective view of the pad of this invention with portions cutaway to show its internal construction.

FIG. 3 illustrates the carrying bag of this invention showing it being used to heat a body infusion fluid container.

FIG. 4 illustrates the recharging of the rechargeable battery pack of this invention.

### DESCRIPTION OF THE PREFERRED EMBODIMENT(S)

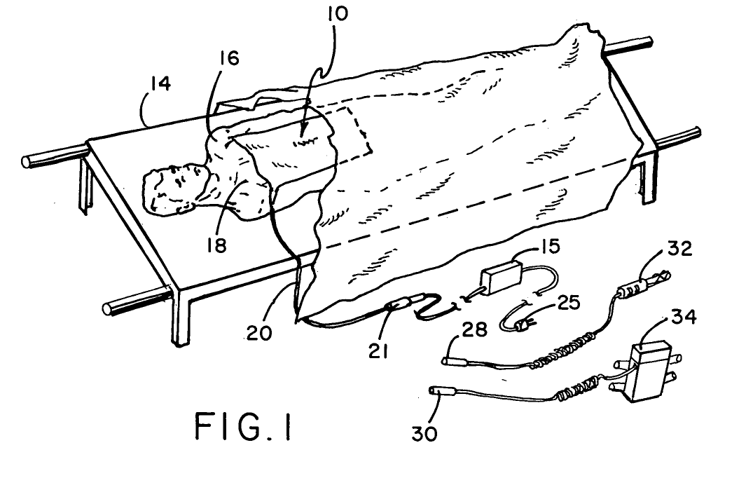

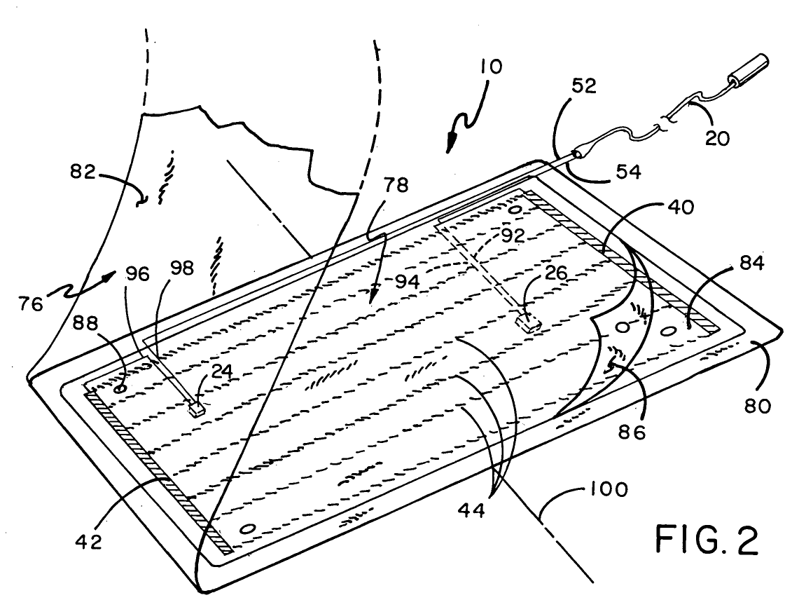

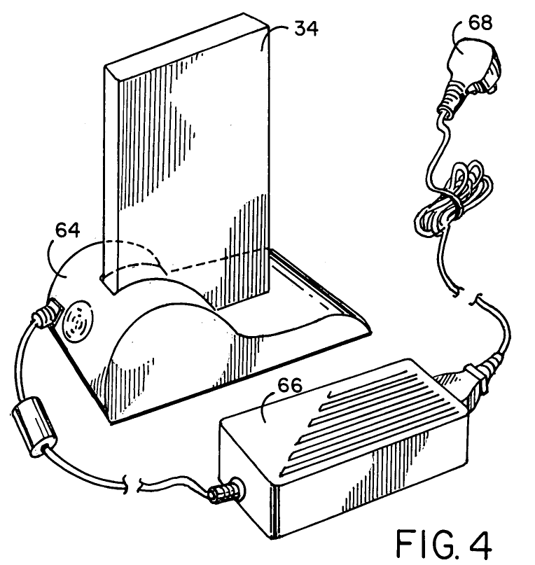

FIG. 1 illustrates the use of pad 10 of this invention placed on patient 16 positioned on stretcher 14 after rescue from a situation where the patient has been exposed to low temperatures and is suffering from hypothermia. In a preferred embodiment pad 10 can be substantially rectangular in shape and measure approximately 40×60 cm in size which is sufficient to cover most adult-size thoraxes. Pad 10 can be placed either flat or folded in half or into quarters directly on thorax 18 or torso of patient 16 under the clothing to warm the patient. Electrical power is received from one of three power sources, a selected one of which is attached to cable connector 21 of input cable 20, such input cable having first wire 52 and second wire 54, as seen in FIG. 2, which input cable 20 extends to pad 10. One type of power supply connected to cable connector 21 can be delivered from an existing local power supply into which plug 25 can be plugged. Such power, being either 110 volt or 230 Volt AC at 50/60 Hz, runs to converter 15 which converts the local power supply voltage to 12 volts AC to pad 10 through cable connector 21. The second type of power supply connector carried in the kit, is a 12 volt DC automobile cigarette lighter type plug 32 which can plug into a cigarette lighter of a vehicle. Cigarette lighter connector 28 can be plugged in turn into cable connector 21 so that pad 10 can be operated off an automobile cigarette lighter or other power supply having a similar cigarette lighter receipt aperture. The third type of power supply connector included in the kit of this invention is a rechargeable battery pack 34, as seen in FIGS. 1 and 4. In one embodiment battery pack 34 can be a 14.5 volt DC lithium ion battery which has approximately a 2.5 hour lifespan. Battery pack 34 can be attached by battery connector 30 to cable connector 21 to provide power to pad 10.

As seen in FIG. 2, the construction of pad 10 includes an outer cover 76 having a bottom member 80 from which upper member 82 has been separated for illustrative purposes, exposing sandwich 78. Sandwich 78 is composed of a first felt-like layer 84 and an attached second felt-like layer 86 which layers enclose the carbon fiber heating elements of the pad. The internal construction of pad 10 of this invention includes first carbon fiber band 40 and second carbon fiber band 42 located, respectively, on opposing first and second sides of pad 10. First and second carbon fiber bands 40 and 42 are each approximately 15 mm wide and each contain 1,000-12,000 carbon microfibers. First wire 52 from input cable 20 extends to wire 96 which runs to first thermal sensor 24, and wire 96 extends from thermal sensor 24 to second carbon fiber band 42. Wire 96 is stripped so that its wire filaments extend down the entire second carbon fiber band 42 and are held in contact therewith by stitching through first felt-like layer 84 and second felt-like layer 86. Heater fiber carbon cross members 44, which are approximately 5 mm wide, extend in a series and are separated from one another by approximately 5 cm. They extend from first carbon fiber band 40 across the pad to second carbon fiber band 42. Second wire 54 coming out of input cable 20 interconnects to second thermal sensor 26 through wire 92, and wire 94 extends from second thermal sensor 26 to first carbon fiber band 40 so as to complete a parallel circuit when electrical current is provided, causing the carbon fibers heating elements to act as 5 ohm resistance at 2-3 amps at 30-35 W and provide heat at the outer surfaces of the pad. Wire 94 is also stripped, exposing its wire filaments that extend in contact with first carbon fiber band 40 to better make electrical contact therewith and with heater cross carbon fiber members 44. First and second carbon fiber bands 40 and 42 as well as heater cross carbon fiber members 44 are sandwiched between first felt-like layer 84 and second felt-like layer 86 which felt-like layers can be adhered to one another such as by stitching through first and second carbon fiber bands 40 and 42 to form a substantially rectangular sandwich 78. In FIG. 2 one corner is shown peeled apart for illustrative purposes, exposing the carbon fiber bands and cross members. Sandwich 78, holding first and second carbon fiber bands 40 and 42 along with heater cross carbon fiber members 44, is contained within the outer covering having upper member 82 and bottom member 80 which can be heat-sealed at their edges to one another beyond the edges of sandwich 78. Sandwich 78 can have an aperture defined at each of its four corners, such as first aperture 88, second aperture 90, third aperture 92, and fourth aperture 94, through which apertures upper member 82 can be heat-sealed to bottom member 80 so as to better retain sandwich 78 within upper and lower members 82 and 80 and prevent sandwich 78 from moving or folding separately from outer cover 76. Upper and lower members 82 and 80 can be made of a soft, bio-compatible PVC material. First and second thermal sensors 24 and 26, as seen in FIG. 1, are self-resetting bi-metallic thermal sensing limit switches and are provided to prevent pad 10 from overheating. First and second thermal sensors 24 and 26, both of which can be self-resetting bi-metallic switches, are spaced apart from one another on opposite outer sides of sandwich 78 with first thermal sensor 24 having a limit of 33/35° C.+/−2° C. and second sensor 26 having a limit of 38/40° C.+/−2° C. First thermal sensor 24 checks that the pad, even when folded in half to a size of approximately 20×30 cm or folded in quarters, does not reach a temperature above 35° C. when it is applied to hypothermia patients. Second thermal sensor 26 acts at a somewhat higher temperature should there be a failure of first thermal sensor 24. First and second thermal sensors 24 and 26 can be positioned on each side of sandwich 78 such that when the pad is folded along plane line 100, the sensors are spaced so as not to overlap on top of one another.

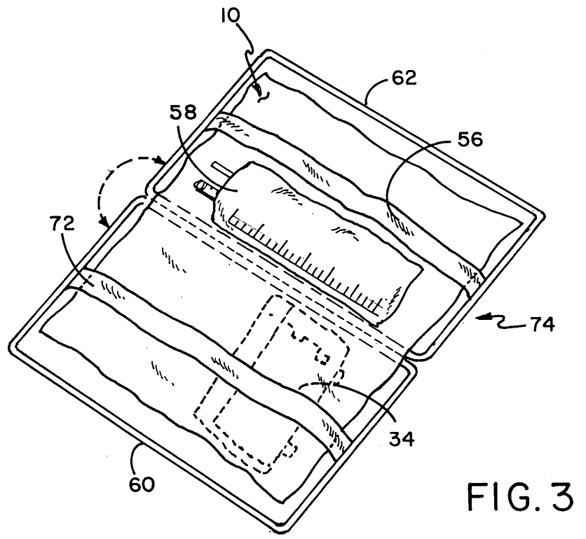

FIG. 3 illustrates carrying bag 74 of the kit of this invention having first and second sides 60 and 62, each having a strap, which carrying bag can be closed by a zipper or other equivalent means of closure. Pad 10 can be contained within second side 62 under second strap 56, when in a storage mode, and the other components of the carrying bag, such as battery charger 64, power connector 66 not shown in FIG. 3, and battery pack 34, as shown in dashed lines, can be held under either first and second straps 56 and 72 when it is stored during nonuse. Pad 10 in FIG. 3, as described below, is shown being used in its second mode of use to warm up body infusion fluid container 58. As such, the power supply connectors would not be left therein so that battery pack 34 is shown in dashed lines to indicate where the power supply connectors would be stored when the carrying bag 74 is used in its storage mode.

In the second mode of usage carrying bag 74, which can be made of nylon or corduroy and have a reflective safety strip on the exterior thereof, can be utilized to warm body infusion fluid containers to be introduced into the body of a patient as it is undesirable to enter fluids that are too cold into a patient. These body infusion fluid containers, such as the body infusion fluid bag 58, as seen in FIG. 3, can be warmed by wrapping one or more of them in pad 10. First and second sides 60 and 62 of carrying bag 74 can be insulated and lined on their inner sides with metallic foil which together act as a heat-reflective, thermally insulating material. When carrying bag 74 is closed, holding heat within the carrying bag, pad 10 warms body infusion fluid bag 58 as well as other body infusion fluid container(s) that are placed within folded pad 10.

Carrying bag 74 when in its storage mode can contain battery charger 64, as seen in FIG. 4. Battery pack 34 can be recharged by placing it in battery charger 64 which is attached to converter 64 which is attached by means of plug 68 to a power source, such as house current and the like. Passing electricity through power converter 66 cuts the house current down to 12 volts so as to recharge battery pack 34 so that the battery can be ready for future use. The pad and other components of the kit of this invention can be easily cleaned and then repackaged in the carrying bag of the kit of the invention so that they are ready for use to warm a patient suffering from hypothermia back to normothermia and to warm up body infusion fluid containers.

Although the present invention has been described with reference to particular embodiments, it will be apparent to those skilled in the art that variations and modifications can be substituted therefor without departing from the principles and spirit of the invention.

I claim:

1. A portable, dual-purpose kit for the treatment of a patient suffering from hypothermia and for the warming of body infusion fluid container(s), comprising:
a carrying bag having first and second sides, each side being insulated and having a metallic foil liner;
a plurality of connector means for providing electrical current;
a pad having:
an outer covering; and
an inner sandwich disposed within said outer covering, said inner sandwich having first, second, third and fourth sides wherein said first and second sides are disposed opposite to each other and said third and fourth sides are disposed opposite to each other, said inner sandwich for production of heat, said inner sandwich having first and second felt-like layers, said inner sandwich having heating elements including first and second carbon fiber bands positioned on said first and second sides of said inner sandwich within said first and second felt-like layers, said inner sandwich having a plurality of carbon fiber cross members spaced apart from one another connecting said first carbon fiber band to said second carbon fiber band with means for said carbon fiber bands and said cross members to receive electrical current from a selected one of said means for providing electrical current for providing heat when said electrical current is provided thereto; and
means for controlling the temperature of said heat within said pad, said pad in a first mode of use for treating a patient suffering from hypothermia when placed on the thorax of said patient, and said pad in a second mode of use when placed within said carrying bag for heating at least one body infusion fluid container.

2. The kit of claim 1 wherein said outer covering is made of a soft, waterproof, PVC material.

3. The kit of claim 2 wherein said plurality of means for providing electrical current contained within said carrying bag include connection means to available house current, connection means to an automobile cigarette lighter, and a battery pack and recharging means.

4. The kit of claim 3 further including at least one thermal sensor, said thermal sensor for shutting off electrical current to said pad's heating element when a predetermined temperature is exceeded.

5. The kit of claim 4 further including a second thermal sensor, said second thermal sensor for shutting off electrical current to said pad's heating element when a temperature higher than said predetermined temperature is exceeded.

6. The kit of claim 5 wherein said outer covering has an upper member and a bottom member, said upper member and said bottom member being adhered to one another along said first, second, third and fourth sides of said inner sandwich; and
said inner sandwich further including at least one aperture defined therein through which said upper member and said bottom member are heat-sealed to one another.

7. The kit of claim 6 wherein said outer covering and inner sandwich are substantially rectangular in shape.

8. The kit of claim 7 further including four apertures, one aperture defined in each corner of said substantially rectangular inner sandwich, said upper member and said bottom member being adhered to one another by heat-sealing through each of said four apertures.

9. The kit of claim 8 wherein said carrying bag has first and second sides which are interconnected together, said first and second sides having, respectively, first and second retention straps for retaining said pad and said plurality of connector means for providing electrical current, all held within said carrying bag.

10. The kit of claim 9 wherein said first and second retention straps help retain said body infusion fluid container(s) within said carrying bag when said kit is used in its second mode of use.

11. A portable pad for the treatment of a patient suffering from hypothermia and for the warming of body infusion fluid container(s), said pad of the type operated by electrical current, comprising:
an outer covering;
an inner sandwich disposed within said outer covering, said inner sandwich having first, second, third and fourth sides wherein said first and second sides are disposed opposite to each other and said third and fourth sides are disposed opposite to each other, said inner sandwich having first and second felt-like layers, said inner sandwich having heating elements including first and second carbon fiber bands positioned on said first and second sides of said inner sandwich within said first and second felt-like layers, said inner sandwich having a plurality of carbon fiber cross members spaced apart from one another connecting said first carbon fiber band to said second carbon fiber band with means for said carbon fiber bands and said cross members to receive said electrical current for providing heat to said inner sandwich; and
means for controlling the temperature of said heat within said inner sandwich, said pad in a first mode of use for treating a patient suffering from hypothermia when said pad is placed on the thorax of said patient, and said pad in a second mode of use for heating at least one body infusion fluid container.

12. The pad of claim 11 wherein said outer covering is made of a soft, waterproof, PVC material.

13. The pad of claim 12 further including at least one thermal sensor, said thermal sensor for shutting off electrical current to said pad's heating element when a predetermined temperature is exceeded.

14. The pad of claim 13 further including a second thermal sensor, said second thermal sensor for shutting off electrical current to said pad's heating element when a temperature higher than said predetermined temperature is exceeded.

15. The pad of claim 14 wherein said outer covering has an upper member and a bottom member, said upper member and bottom member being adhered to one another along said first, second, third and fourth sides of said inner sandwich; and
said inner sandwich further including at least one aperture defined therein through which said upper and bottom members are further heat-sealed to one another.

16. The pad of claim 15 wherein said outer covering and inner sandwich are substantially rectangular in shape.

17. The pad of claim 16 further including four apertures, one aperture defined in each corner of said substantially rectangular inner sandwich, said upper member and said bottom member being adhered to one another by heat-sealing through each of said four apertures.
